(19) United States
(12) Patent Application Publication
(10) Pub. No.: US 2020/0212436 A1
(43) Pub. Date: Jul. 2, 2020

(54) ELECTRIC VEHICLE BATTERY CELL

(71) Applicant: SF Motors, Inc., Santa Clara, CA (US)

(72) Inventors: Tianyuan Liu, Santa Clara, CA (US); Ying Liu, Santa Clara, CA (US); Yifan Tang, Santa Clara, CA (US)

(21) Appl. No.: 16/236,890

(22) Filed: Dec. 31, 2018

(51) Int. Cl. H01M 4/36; H01M 4/62; H01M 4/525; H01M 4/66; H01M 2/10; H01M 4/04; B60L 50/64

(52) U.S. Cl. CPC H01M 4/366; H01M 4/625; H01M 4/525; H01M 4/661; H01M 2004/028; H01M 4/0404; B60L 50/64; H01M 2220/20; H01M 2/1077

(57) ABSTRACT

A battery cell of a battery pack to power an electric vehicle is provided. The battery cell can include a housing defining an inner region. A plurality of cathodes can be disposed within the inner region. Each of the plurality of cathodes can include an aluminum material comprises a first face and a second face and a coating disposed on the first face and the second face. The coating can include lithium nickel cobalt aluminum oxide particles and a linear carbon conductive additive to form a connection between a plurality of the lithium nickel cobalt aluminum oxide particles.

### BACKGROUND

Batteries can include electrochemical materials to supply electrical power to electrical components connected thereto. Such batteries can provide electrical energy to electrical systems.

### SUMMARY

Systems and methods described herein relates to a battery cell of a battery pack of an electric vehicle. The battery cell can include lithium ion (Li-ion) batteries having a plurality of high loading electrodes, such as cathodes or anodes. For example, cathodes can be formed having a predetermined thickness and using a high active material percentage to improve the energy density of the respective Li-ion batteries. The active materials can include lithium nickel cobalt aluminum oxide (NCA). The active materials can be combined with linear carbon conductive additives. The linear carbon conductive additives can include carbon nanotubes (CNT) or vapor grown carbon nanofiber (VGCF). The active materials combined with the linear carbon conductive additives can form a three-dimensional (3-D) network for the active materials. For example, point-to-line type connections can be formed between the active materials and the linear carbon conductive additives instead of point-to-point type connections. The point-to-line connections can improve the mechanical and rate performance of the cathodes (e.g., electrodes) by distributing electrolytes among the respective active material particles. For example, the point-to-line connections form pathways that enable electrolytes to enter or otherwise penetrate the active material particles coupled with the respective linear carbon conductive additive and increase the electrolyte distribution within the respective cathode (e.g., electrode). The combination of active materials and linear carbon conductive additives can provide a cathode having a greater density as compared to other types of electrodes used in battery cell technology.

At least one aspect is directed to a battery cell of a battery pack to power an electric vehicle. The battery cell can include a housing defining an inner region and a plurality of cathodes that extend into the inner region. Each of the plurality of cathodes can include an aluminum material having a first face and a second face. A coating can be disposed on the first face and the second face. The coating can include lithium nickel cobalt aluminum oxide particles and a linear carbon conductive additive to form a connection between a plurality of the lithium nickel cobalt aluminum oxide particles.

At least one aspect is directed to a method of providing a battery cell of a battery pack to power an electric vehicle. The method can include providing a battery pack having a battery cell. The battery cell can include a housing that include a first end and a second end and defines an inner region. The method can include forming a coating for a plurality of cathodes. The coating having lithium nickel cobalt aluminum oxide particles and a linear carbon conductive additive that form a connection between a plurality of the lithium nickel cobalt aluminum oxide particles. The method can include applying the coating to a first face and a second face of an aluminum material for each of the plurality of cathodes. The method can include disposing the plurality of cathodes into the inner region of the housing.

At least one aspect is directed to a method. The method can provide a battery cell of a battery pack of an electric vehicle. The battery cell can include a housing defining an inner region and a plurality of cathodes that extend into the inner region. Each of the plurality of cathodes can include an aluminum material having a first face and a second face. A coating can be disposed on the first face and the second face. The coating can include lithium nickel cobalt aluminum oxide particles and a linear carbon conductive additive to form a connection between a plurality of the lithium nickel cobalt aluminum oxide particles.

At least one aspect is directed to an electric vehicle. The electric vehicle can include a battery cell of a battery pack of an electric vehicle. The battery cell can include a housing defining an inner region and a plurality of cathodes that extend into the inner region. Each of the plurality of cathodes can include an aluminum material having a first face and a second face. A coating can be disposed on the first face and the second face. The coating can include lithium nickel cobalt aluminum oxide particles and a linear carbon conductive additive to form a connection between a plurality of the lithium nickel cobalt aluminum oxide particles.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing. In the drawings:

FIG. 1 is a block diagram depicting a cross-sectional view of an example battery cell for a battery pack in an electric vehicle having a plurality of cathodes, according to an illustrative implementation;

FIG. 2 is a diagram depicting a view of active materials particles coupled with linear carbon conductive additives, according to an illustrative implementation;

FIG. 3 is a block diagram depicting a cross-sectional view of an example battery pack for holding battery cells in an electric vehicle;

FIG. 4 is a block diagram depicting a cross-sectional view of an example electric vehicle installed with a battery pack;

FIG. 5 is a flow diagram depicting an example method of providing a battery cell of a battery pack to power electric vehicles; and

FIG. 6 is a flow diagram depicting an example method of providing battery cells for battery packs for electric vehicles.

### DETAILED DESCRIPTION

Following below are more detailed descriptions of various concepts related to, and implementations of battery cells for battery packs in electric vehicles. The various concepts introduced above and discussed in greater detail below can be implemented in any of numerous ways.

Systems and methods described herein relate to a battery cell of a battery pack of an electric vehicle having a plurality of cathodes disposed in an inner region of the battery cell. The battery cells described herein can be formed having a plurality of cathodes with a high percentage of active material to improve the energy density of the respective battery cells. For example, the cathodes (or electrodes) can be formed having an aluminum material with a coating disposed on one or more surfaces of the aluminum material. The coating can include active materials and linear carbon conductive additives. The coating can increase a thickness of the cathodes to improve a mechanical and an electrical performance of the cathodes. For example, the linear carbon conductive additives can form point-to-line connections with the active materials. The point-to-line connections can form a three-dimensional structured network to distribute electrolytes between the active material particles forming the respective cathode and increase the energy density of the respective cathode.

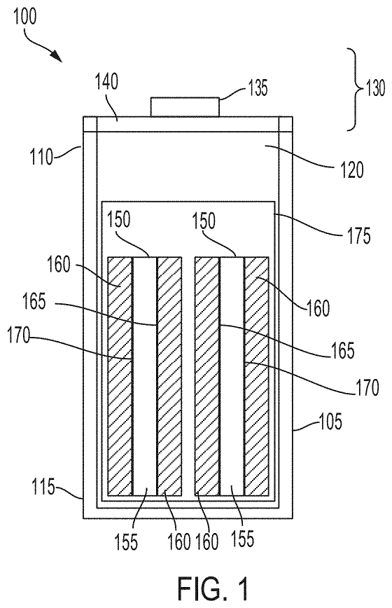

FIG. 1, among others, depicts a cross-sectional view of a battery cell 100 for a battery pack in an electric vehicle. The battery cell 100 can provide energy or store energy for an electric vehicle. For example, the battery cell 100 can be included in a battery pack used to power an electric vehicle. The battery cell 100 can include at least one housing 105. The housing 105 can have a first end 110 and a second end 115. The battery cell 100 can be a lithium-air battery cell, a lithium ion battery cell, a nickel-zinc battery cell, a zinc-bromine battery cell, a zinc-cerium battery cell, a sodium-sulfur battery cell, a molten salt battery cell, a nickel-cadmium battery cell, or a nickel-metal hydride battery cell, among others. The housing 105 can be included or contained in a battery pack (e.g., a battery array or battery module) installed a chassis of an electric vehicle. The housing 105 can have the shape of a cylindrical casing or cylindrical cell with a circular, ovular, or elliptical base, as depicted in the example of the battery cell of FIG. 1. A height of the housing 105 can be greater than a width of the housing 105. For example, the housing 105 can have a length (or height) in a range from 65 mm to 75 mm and a width (or diameter for circular examples) in a range from 15 mm to 27 mm. In some examples the width or diameter of the housing 105 can be greater than the length (e.g., height) of the housing 105. The housing 105 can be formed from a prismatic casing with a polygonal base, such as a triangle, square, a rectangular, a pentagon, or a hexagon, for example. A height of such a prismatic cell housing 105 can be less than a length or a width of the base of the housing 105. The battery cell 100 can be a cylindrical cell 21 mm in diameter and 70 mm in height. Other shapes and sizes are possible, such as a rectangular cells or rectangular cells with rounded edges, of cells between 15 mm to 27 mm in diameter or width, and 65 mm to 75 mm in length or height.

The housing 105 of the battery cell 100 can include at least one electrically or thermally conductive material, or combinations thereof. The electrically conductive material can also be a thermally conductive material. The electrically conductive material for the housing 105 of the battery cell 100 can include a metallic material, such as aluminum, an aluminum alloy with copper, silicon, tin, magnesium, manganese or zinc (e.g., of the aluminum 4000 or 5000 series), iron, an iron-carbon alloy (e.g., steel), silver, nickel, copper, and a copper alloy, among others. The electrically conductive material and thermally conductive material for the housing 105 of the battery cell 100 can include a conductive polymer. To evacuate heat from inside the battery cell 100, the housing 105 can be thermally coupled to a thermoelectric heat pump (e.g., a cooling plate) via an electrically insulating layer. The housing 105 can include an electrically insulating material. The electrically insulating material can be a thermally conductive material. The electrically insulating and thermally conductive material for the housing 105 of the battery cell 100 can include a ceramic material (e.g., silicon nitride, silicon carbide, titanium carbide, zirconium dioxide, beryllium oxide, and among others) and a thermoplastic material (e.g., polyethylene, polypropylene, polystyrene, or polyvinyl chloride), among others. To evacuate heat from inside the battery cell 100, the housing 105 can be thermally coupled to a thermoelectric heat pump (e.g., a cooling plate). The housing 105 can be directly thermally coupled to the thermoelectric heat pump without an addition of an intermediary electrically insulating layer.

The housing 105 of the battery cell 100 can include the first end 110 (e.g., top portion) and the second end 115 (e.g., bottom portion). The housing 105 can define an inner region 120 between the first end 110 and the second end 115. For example, the inner region 120 can include an interior of the housing 105 or an inner area formed by the housing 105. The first end 110, inner region 120, and the second end 115 can be defined along one axis of the housing 105. For example, the inner region 120 can have a width (or diameter for circular examples) of 2 mm to 6 mm and a length (or height) of 50 mm to 70 mm. The width or length of the inner region 120 can vary within or outside these ranges. The first end 110, inner region 120, and second end 115 can be defined along a vertical (or longitudinal) axis of cylindrical casing forming the housing 105. The first end 110 at one end of the housing 105 (e.g., a top portion as depicted in FIG. 1). The second end 115 can be at an opposite end of the housing 105 (e.g., a bottom portion as depicted in FIG. 1). The end of the second end 115 can encapsulate or cover the corresponding end of the housing 105.

The diameter (or width) of the first end 110 can be in a range from 15 mm to 27 mm. The diameter (or width) of the second end 115 can be in a range from 15 mm to 27 mm. The diameter (or width) can correspond to a shortest dimension along an inner surface of the housing 105 within the first end 110 or second end 115. The width can correspond to a width of a rectangular or polygonal lateral area of the first end 110 or second end 115. The diameter (or width) can correspond to a diameter of a circular or elliptical lateral area of the first end 110 or second 115. The width of the first end 110 (not including the indentation) can be less than the width of the second end 115 of the housing 105. The lateral area of the first end 110 (not including the indentation) can be less than the lateral area of the second end 115 of the housing 105.

At least one lid 130 can be disposed proximate to the first end 110 of the housing 105. The lid 130 can be disposed onto the first lateral end 110 of the housing 105. The lid 130 can include a first portion 135 and a second portion 140. The second portion 140 can couple the lid 130 with the first end 110 of the housing 105. The second portion 140 can be crimped onto, clipped onto, or welded with the first end 110 to couple the lid 130 with the first end 110 of the housing 105. The coupling (e.g., crimped coupling, welded coupling) between the second portion 140 and the first end 110 of the housing 105 can form a hermetic seal, a fluid resistant seal, or a hermetic seal and a fluid resistant seal between the lid 130 and the housing 105, for example, so that the fluid or material within the inner region 120 does not leak from its location within the housing 105.

The first portion 135 can couple with the second portion 140. For example, the first portion 135 can be welded with the second portion 140 to form the lid 130. The first portion 135 can be formed having a shape corresponding to the shape of the second portion 140. The first portion 135 can be formed having a shape corresponding to the shape of the housing 105. For example, the first portion 135 can be formed having a circular, ovular, elliptical, rectangular, or square shape. The first portion 135 can be formed from the same material as the second portion 140. The first portion 135 can be formed from the same material as the housing 105. The first portion 135 can be formed from a different material from the material forming the housing 105. For example, the first portion 135 can include a metallic material, aluminum, an aluminum alloy with copper, silicon, tin, magnesium, manganese or zinc (e.g., of the aluminum 4000 or 5000 series), iron, an iron-carbon alloy (e.g., steel), silver, nickel, copper, and a copper alloy, among others. The first portion 135 can have a height (e.g., length, vertical length) in a range from 3 mm to 20 mm. The height of the first portion 135 can vary within or outside this range. The first portion 135 can have a diameter in a range from 0.5 mm to 18 mm. The diameter of the first portion 135 can vary within or outside this range. The first portion 135 can have a thickness (e.g., distance from an inner surface to an outer surface of the first portion 135) in a range from 0.1 mm to 1 mm (e.g., 0.35 mm). The thickness of the first portion 135 can vary within or outside this range. The lid 130 can be formed such that the first portion 135 has a different height with respect to a first surface (e.g., top surface) of the first end 110 of the housing 105 as compared to a height of the second portion 140. For example, the first portion 135 can have a first height with respect to the first surface of the first end 110 of the housing 105 and the second portion 140 can have a second height with respect to the first surface of the first end 110 of the housing 105. The first height can be greater than the second height. For example, the first portion 135 can be formed having a greater height than the second portion 140. The lid 130 can be formed such that the first portion 135 has a different diameter than the second portion 140. For example, the first portion 135 can have a first diameter and the second portion 140 can have a second diameter. The first diameter can be less than the second diameter. For example, the first portion 135 can be formed within the diameter of the second portion 140 and form a middle region of the second portion 140.

The second portion 140 can be formed having a shape corresponding to the shape of the housing 105. For example, the second portion 140 can be formed having a circular, ovular, elliptical, rectangular, or square shape. The second portion 140 can be formed from the same material as the housing 105. The second portion 140 can be formed from a different material from the material forming the housing 105. For example, the second portion 140 can include, for example, a metallic material, aluminum, an aluminum alloy with copper, silicon, tin, magnesium, manganese or zinc (e.g., of the aluminum 4000 or 5000 series), iron, an iron-carbon alloy (e.g., steel), silver, nickel, copper, and a copper alloy, among others. The second portion 140 can have a diameter in a range from 15 mm to 27 mm. The diameter of the second portion 140 can vary within or outside this range. The second portion 140 can have a height (e.g. vertical width, vertical length) in a range from 0.5 mm to 2 mm (e.g., 1 mm). The height of the second portion 140 can vary within or outside this range. The second portion 140 can have a thickness (e.g., distance from an inner surface to an outer surface of the second portion 140) in a range from 0.1 mm to 1 mm (e.g., 0.35 mm). The thickness of the second portion 140 can vary within or outside this range.

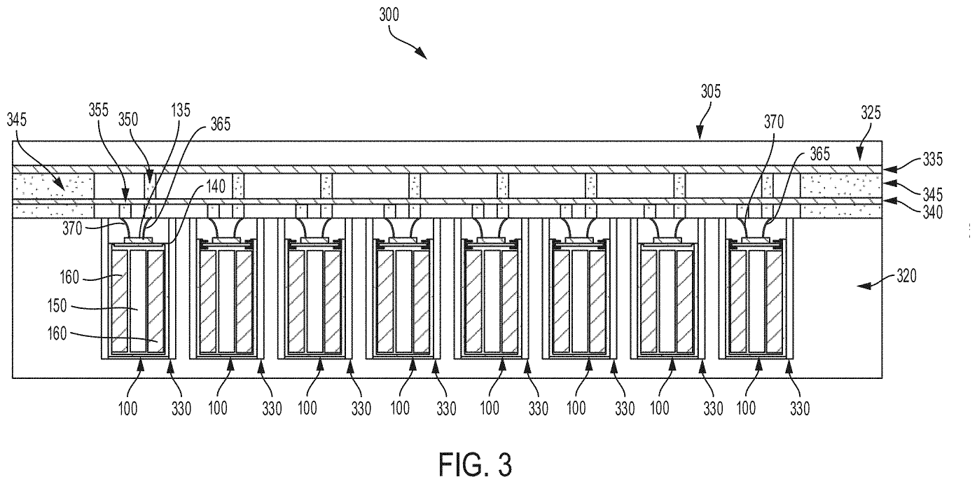

The lid 130 can include a first polarity layer (e.g., positive polarity), a second polarity layer (e.g., negative polarity), or both a first polarity and a second polarity. For example, the second portion 140 can be a first polarity layer (e.g., positive polarity) or a second polarity layer (e.g., negative polarity). The first portion 135 can be a first polarity layer (e.g., positive polarity) or a second polarity layer (e.g., negative polarity). The second portion 140 can have a different polarity from the first portion 135. The second portion 140 can have the same polarity as the first portion 135. The second portion 140 and the first portion 135 can have the same polarity as the housing 105. The second portion 140 or the first portion 135 can have a different polarity from the housing 105. The housing 105 can be formed from non-conductive material and the second portion 140 can have a first polarity and the first portion 135 can have a second polarity. The second polarity can be different from the first polarity. The second portion 140 or the first portion 135 can operate as a first polarity terminal (e.g., positive terminal) of the battery cell 100. The second portion 140 or the first portion 135 can operate as a second polarity terminal (e.g., negative terminal) of the battery cell 100. For example, the battery cell 100 can couple with a first polarity busbar and a second polarity busbar (e.g., positive and negative busbars, positive and negative current collectors) of a battery pack of an electric vehicle through the second portion 140 or the first portion 135 of the lid 130 (as shown in FIG. 3). Via a module tab connection (or other techniques such as wire bonding of a wire), the second portion 140 or the first portion 135 can couple the battery cell 100 with busbars of the battery pack from the same end or common end (e.g., top or bottom) or from longitudinal sides of the battery cell 100. The battery pack can be disposed in an electric vehicle to power a drive train of the electric vehicle.

For example, the battery cell can include a plurality of electrodes 150. The electrodes 150 can be referred to as cathodes 150 or anodes 150. For example, the electrodes 150 can include cathodes 150. The electrodes 150 can include anodes 150. The electrodes 150 can include cathodes 150 and anodes 150. For example, the plurality of electrodes 150 can include a plurality of cathodes 150 and a plurality of anodes 150. The cathodes 150 can electrically couple with anodes 150 within the inner region 120 of the housing 105. The cathodes 150 and the anodes 150 can be arranged in a stack formation. The cathodes 150 can include any substance through which electrical current flows out of an electrolyte disposed within the inner region 120 of the housing 105. The anodes 150 can include any substance through which electrical current flows into the electrolyte disposed within the inner region 120 of the housing 105. For a lithium-ion battery cell 100, for example, the cathodes 150 can include an aluminum material (e.g., aluminum foil material), a lithium-metal oxide (e.g., lithium cobalt oxide (LiCoO2) and lithium manganese oxide (LiMn2O4)), a vanadium oxide, (e.g., VO) or an olivine (e.g., LiFePO4), among others. The anodes 150 can include carbonaceous materials (e.g., graphites, carbon fibers, active carbons, and carbon blacks), lithium titanium oxide (Li4Ti5O12), a metal alloy (e.g., using aluminum, bismuth, antimony, zinc, magnesium, copper, iron, nickel, etc.) or a composite including metal and carbonaceous materials. Electrical current can flow through a tab connected to one or more cathodes 150 to a tab connected to one or more anodes 150 in the respective battery cell 100.

The cathodes 150 can include an aluminum material 155 having a coating 160 disposed on or about a first face 165 of each of the cathodes 150 and a second face 170 of each of the cathodes 150. The aluminum material 155 can include an aluminum foil, a metallic material, or a shim sheet formed from aluminum material. The aluminum material 155 can be formed in a variety of different shapes. For example, the aluminum material 155 can have a rectangular shape, square shape, or circular shape. The aluminum material 155 can have a length in a range from 1 m to 10 m (e.g., 3 m, 6 m). The length of the aluminum material 155 can vary within or outside this range. The aluminum material 155 can have a width in a range from 150 mm to 200 mm (e.g., 200 mm). The width of the aluminum material 155 can vary within or outside this range. The aluminum material 155 can have a thickness in a range from 12 μm to 20 μm (e.g., 12 μm, 20 μm). The thickness of the aluminum material 155 can vary within or outside this range.

The first face 165 and the second face 170 can refer to side surfaces or side edges of the respective cathode 150. The first face 165 and the second face 170 can refer to a top surface or a bottom surface of the respective cathode 150. The coating 160 can be disposed on two surfaces of each of the cathodes 150. For example, the coating 160 can be disposed on opposing or opposite faces or side surfaces of each of the cathodes 150. The coating 160 can be disposed on at least one surface of the cathodes 150. The coating 160 can be disposed on multiple surfaces of the cathodes 150. For example, the coating 160 can be disposed on two different surfaces of the cathodes 150 or more than two different surfaces of the cathodes 150. The coating 160 can be disposed on the one or more faces 165, 170 of the aluminum material 155 having a thickness in a range from 230 μm to 250 μm.

The cathodes 150 (or electrodes) can be disposed or housed within a container 175 within the inner region. For example, the container 175 can house one or more cathodes 150, one or more anodes 150, and an electrolyte. The one or more cathodes 150 can electrically couple with the one or more anodes 150 to pass electrons from the electrolyte between the cathodes 150 and anodes 150. For example, the electrolyte can include any electrically conductive solution, dissociating into ions (e.g., cations and anions). For a lithium-ion battery cell, for example, the electrolyte can include a liquid electrolyte, such as lithium bisoxalatoborate (LiBC4O8 or LiBOB salt), lithium perchlorate (LiClO4), lithium hexaflourophosphate (LiPF6), and lithium trifluoromethanesulfonate (LiCF3SO3). The electrolyte can include a polymer electrolyte, such as polyethylene oxide (PEO), polyacrylonitrile (PAN), polymethyl methacrylate (PMMA) (also referred to as acrylic glass), or polyvinylidene fluoride (PVdF). The electrolyte can include a solid-state electrolyte, such as lithium sulfide (Li2S), magnesium, sodium, and ceramic materials (e.g., beta-alumna). The electrolyte can include a first polarity electronic charge region or terminus and a second polarity electronic charge region or terminus. For example, the electrolyte can include a positive electronic charge region or terminus and a negative electronic charge region or terminus. A first polarity tab (e.g., positive tab) can couple a first polarity region of the electrolyte with a first polarity layer or first polarity region of the lid 130 to form a first polarity surface area (e.g., positive surface area) on the lid 130 for first polarity wire bonding. For example, the second portion 140 or the first portion 135 can correspond to a first polarity layer or first polarity region of the lid 130. At least one second polarity tab (e.g., negative tab) can couple a second polarity region of the electrolyte (e.g., negative region of electrolyte) with the surface of the housing 105 or a second polarity layer or second polarity region of a lid 130. For example, a second polarity region of the electrolyte can couple with one or more surfaces of the housing 105 or a second polarity layer or second polarity region of the lid 130, such as to form a second polarity surface area (e.g., negative surface area) on the lid 130 for second polarity wire bonding. For example, the second portion 140 or the first portion 135 can correspond to a second polarity layer or second polarity region of the lid 130.

The first portion 135 or the second portion 140 of the lid 130 can couple with one or more electrolytes disposed within the container 175. For example, the first portion 135 or the second portion 140 can couple with at least one electrolyte through one or more tabs. A first polarity tab can couple the electrolyte (e.g., positive region of the electrolyte) with first portion 135 or the second portion 140. The first polarity tab can extend from a first polarity region of the electrolyte to at least one surface of the first portion 135 or the second portion 140. A second polarity tab can couple the electrolyte with the first portion 135 or the second portion 140. The second polarity tab can extend from a second polarity region of the electrolyte to at least one surface (e.g., bottom surface) of the first portion 135 or the second portion 140. The second polarity tab can electrically couple the first portion 135 or the second portion 140 with the second polarity region of the electrolyte. When the first portion 135 or the second portion 140 is coupled with the electrolyte through the second polarity tab, the housing 105 may include non-conductive material. The lid 130 can include at least one insulation material. The at least one insulation material can separate or electrically isolate the first portion 135 and the second portion 140 when the first portion 135 and the second portion 140 have different polarities. The insulation material may include dielectric material. For example, the insulation material can include at least one surface coupled with at least one surface of the first portion 135 and a second surface coupled with the second portion 140 such that the insulation material is disposed between the first portion 135 and the second portion 140.

The battery cells 100 described herein can include both the positive terminal and the negative terminal disposed at a same lateral end (e.g., the top end) of the battery cell 100. For example, the lid 130 can provide a first polarity terminal (e.g., positive terminal) for the battery cell 100 at the first end 110 and a second polarity terminal (e.g., negative terminal) for the battery cell 100 at the first end 110. Having both terminals, for the positive and the negative terminals on one end of the battery cell 100 can eliminate wire bonding to one side of the battery pack and welding of a tab to another side of the battery cell 100 (e.g., the bottom end or the crimped region). In this manner, a terminal or an electrode tab along the bottom of the battery cell 100 can be eliminated from the structure. Thus improving the pack assembly process by making it easier to bond the wire to each of the first polarity terminal (e.g., positive terminal) and the second polarity terminal (e.g., negative terminal) of the battery cell 100. For example, the battery cell 100 can be attached to a first polarity busbar by bonding at least one wire between the at least one surface of the lid 130 and the first polarity busbar. The battery cell 100 can be attached to a second polarity busbar by bonding at least one wire between at least one surface of the lid 130 and the second polarity busbar. Each battery cell 100 can be attached to the second polarity busbar by bonding at least one wire to a side surface of the first end 110 or second end 115 (e.g., bottom surface) of the housing 105 of the battery cell 100.

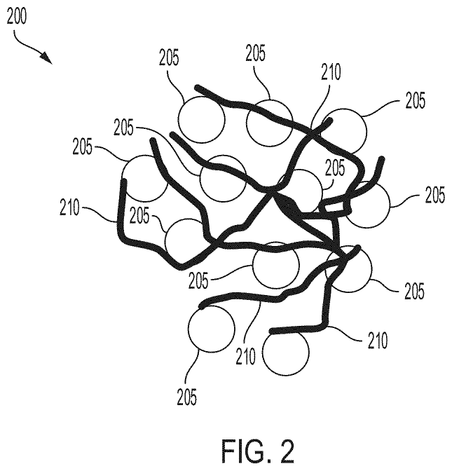

FIG. 2, among others, depicts a view 200 of a coating 160 of a cathode 150. The coating 160 can include a plurality of active materials 205 (e.g., active material particles) coupled with a plurality of linear carbon conductive additives 210. For example, the active material 205 can include, for example, lithium nickel cobalt aluminum oxide (NCA). The linear carbon conductive additives 210 can include, for example, carbon nanotubes (CNT) or vapor grown carbon nanofiber (VGCF). The linear carbon conductive additives 210 can have or provide better electrical conductivity and mechanical properties. For example, the linear carbon conductive additives 210 can include or be formed having a wire or tube structure that provides a much larger aspect ratio as compared to other forms of carbon additives. The diameter of the linear carbon conductive additives 210 can be in the range of 1 nm to 200 nm. The diameter of the linear carbon conductive additives 210 can vary within or outside this range. The length of the linear carbon additives 210 can be in a range of 200 nm to 200 um. The length of the linear carbon conductive additives 210 can vary within or outside this range.

The coating 160 can include a plurality of materials combined to include more active materials 205 as a percentage by weight as compared to other coatings used in battery cell technology and provide a thicker and mechanically stronger cathode 150 (or electrode 150) as compared to other electrodes used in battery cell technology. For example, the active materials 205 can be combined with various combinations of the linear carbon conductive additives 210, a binder (e.g., Polyvinylidene fluoride powder, PVDF powder), a conductive agent (e.g., super-P, carbon black super-P), and a coating agent (e.g., N-Methyl-2-pyrrolidone (NMP)) to form the coating 160. The coating 160 can be formed as a slurry and be formed having a first percentage by weight of active materials 205, a second percentage by weight of binder, a third percentage by weight of conductive agent, and a fourth percentage by weight of linear carbon conductive additives 210 with the first, second, third, and fourth percentages by weight adding up to 100 percent.

The first percentage of active materials 205 (e.g., NCA) can be in a range from 95% by weight to 98% by weight (e.g., 97.4% by weight). The first percentage by weight of active materials 205 can vary within or outside this range. For example, the coating 160 can include between 0.95% by weight (wt %) and 98% by weight (wt %) of lithium nickel cobalt aluminum oxide particles. The coating 160 can include 97.4% by weight (wt %) of lithium nickel cobalt aluminum oxide particles. The coating 160 can include 97% by weight (wt %) of lithium nickel cobalt aluminum oxide particles. The second percentage of binder can be in a range from 1% by weight to 1.5% by weight. The second percentage by weight of binder can vary within or outside this range. For example, the coating 160 can include a 1.5% by weight (wt %) of a binder solvent of PVDF. The third percentage of conductive agent can be in a range from 0.9% by weight to 1.1% by weight (e.g., 1% by weight). The third percentage by weight of conductive agent can vary within or outside this range. For example, the coating 160 can include a 1.0% by weight (wt %) of a conductive agent of super-P material. The fourth percentage of linear carbon conducive additives 210 can be in a range from 0.05% by weight to 1% by weight (e.g., 0.1% by weight). The fourth percentage by weight of linear carbon conductive additives 210 can vary within or outside this range. For example, the coating 160 can include between 0.05% by weight (wt %) and 1.0% by weight (wt %) of carbon nanotubes. The coating 160 can include 0.10% by weight (wt %) of carbon nanotubes. The coating 160 can include between 0.30% by weight (wt %) and 0.70% by weight (wt %) of vapor grown carbon nanotubes. The coating 160 can include between 0.50% by weight (wt %) of vapor grown carbon nanotubes. The coating 160 can include less than four percentages or more than four percentages with the number of percentages based in part on the number of elements forming the respective coating 160.

The coating 160 can provide a greater percentage by weight of active materials 205 by coupling the active materials using the linear carbon conductive additives 210. The linear carbon conductive additives 210 can form a three-dimensional (3D) structured network for and with the active material particles 205. For example, the linear carbon conductive additives 210 can form point-to-line connections with the active material particles 205. The linear carbon conductive additives 210 can connect or couple multiple active material particles 205 together to form a linear structure (e.g., additive structure) in contrast to point-to-point connections which connect one particle to a next or subsequent particle (e.g., one to one connection). For example, a point-to-line connection can be formed between the linear carbon conductive additives 210 and three or more active material particles 205 to provide a 3D conductive network between the multiple active material particles 205. The point-to-line connections formed between the linear carbon conductive additives 210 and the active material particles 205 can improve a mechanical and a rate of performance of the cathode 150. For example, the linear carbon conductive additives 210 can form pathways for electrolytes to penetrate each of the multiple active material particles 205 coupled with the respective linear carbon conductive additives 210. Thus, the active materials 205 can receive or take in a greater amount of the electrolyte. The linear carbon conductive additives 210 can increase the electrode density in a range from 3.5 g/cm³ to 3.7 g/cm³. For example, the electrode density can be 3.6 g/cm³ when the linear carbon conductive additives 210 include CNT. The electrode density can be 3.65 g/cm³ when the linear carbon conductive additives 210 include VGCF.

The 3D conductive network formed between the active material particles 205 and linear carbon conductive additives 210 can reinforce the cathode 150 (e.g., electrode) and improve the mechanical stability during operation or cycling of the cathode 150. For example, the cathode 150 can be formed having a greater density due to the increased electrolyte absorption. The cathode 150 can be formed denser without blocking pores such that electrons can still move freely. The cathode 150 can be formed having a greater or increased amount of active material 205 due to the point-to-line connections formed by the linear carbon conductive additives 210 as the linear carbon conductive additives 210 can link multiple active material particles (e.g., more than two active material particles). The cathode 150 can be formed having a decreased amount or using less linear carbon conductive additives 210 as a reduced number of linear carbon conductive additives 210 can be used to link multiple active material particles (e.g., more than two active material particles).

The linear carbon conductive additives 210 can include a hollow shape or tubular shape. The tubular shape of the linear carbon conductive additives 210 can provide or facilitate electrolyte absorption between the active material particles 205. For example, electrolytes can penetrate each of the respective active materials 205 coupled with a linear carbon conductive additive 210 via the pathway formed by the respective linear carbon conductive additive 210. The increased or better electrolyte absorption properties provided by the linear carbon conductive additives 210 can improve the active material particles 205 usage when the cathode 150 (e.g., electrode) becomes thicker. For example, less linear carbon conductive additives can be used to connect multiple active material particles (e.g., more than two active material particles). The linear carbon conductive additives 210 can increase the adhesion of coating 160 with a reduced amount of binder. Thus, the reduced amount of linear carbon conductive additives and binder can provide more area or space within a respective cathode 150 for active material particles 205. For example, the active materials 205 percentage within a respective cathode can be enhanced to a percentage in a range from 95% by weight to 99% weight (e.g., greater than 97% by weight).

FIG. 3 depicts a cross-section view 300 of a battery pack 305 to hold at least one battery cell 100. For example, the battery pack 305 can include battery cells 100 having at least one cathode 150. The cathode 150 can include an aluminum material 155 having a coating 160 disposed on one or more faces or surfaces of the aluminum material 155. The battery cell 100 can be disposed in a battery pack 305 having multiple battery cells 100. The battery pack 305 can include a single battery cell 100 having at least one cathode 150 that includes an aluminum material 155 having a coating 160 disposed on one or more faces or surfaces of the aluminum material 155. The battery pack 305 can include multiple battery cells 100 having at least one cathode 150 that includes an aluminum material 155 having a coating 160 disposed on one or more faces or surfaces of the aluminum material 155.

The battery cells 100 can have an operating voltage in a range from 2.5 V to 5 V (e.g., 2.5 V to 4.2 V). The operating voltage of the battery cell 100 can vary within or outside this range. The battery pack 305 can include a battery case 320 and a capping element 325. The battery case 320 can be separated from the capping element 325. The battery case 320 can include or define a plurality of holders 330. Each holder 330 can include a hollowing or a hollow portion defined by the battery case 320. Each holder 330 can house, contain, store, or hold a battery cell 100. The battery case 320 can include at least one electrically or thermally conductive material, or combinations thereof. The battery case 320 can include one or more thermoelectric heat pumps. Each thermoelectric heat pump can be thermally coupled directly or indirectly to a battery cell 100 housed in the holder 330. Each thermoelectric heat pump can regulate temperature or heat radiating from the battery cell 100 housed in the holder 330. The first bonding element 365 and the second bonding element 370 can extend from the battery cell 100 through the respective holder 330 of the battery case 320. For example, the first bonding element 365 or the second bonding element 370 can couple with the second portion 140 of the lid 130, the first portion 135 of the lid 130 or housing 105.

Between the battery case 320 and the capping element 325, the battery pack 305 can include a first busbar 335, a second busbar 340, and an electrically insulating layer 345. The first busbar 335 and the second busbar 340 can each include an electrically conductive material to provide electrical power to other electrical components in the electric vehicle. The first busbar 335 (sometimes referred to herein as a first current collector) can be connected or otherwise electrically coupled to the first bonding element 365 extending from each battery cell 100 housed in the plurality of holders 330 via a bonding element 350. The bonding element 350 can include electrically conductive material, such as a metallic material, aluminum, or an aluminum alloy with copper. The bonding element 350 can extend from the first busbar 335 to the first bonding element 365 extending from each battery cell 100. The bonding element 350 can be bonded, welded, connected, attached, or otherwise electrically coupled to the first bonding element 365 extending from the battery cell 100. The first bonding element 365 can define the first polarity terminal for the battery cell 100. The first bonding element 365 can include a first end coupled with a surface of the lid 130 (e.g., second portion 140, first portion 135) and a second end coupled with a surface of the bonding element 350. The first busbar 335 can define the first polarity terminal for the battery pack 305. The second busbar 340 (sometimes referred to as a second current collector) can be connected or otherwise electrically coupled to the second bonding element 370 extending from each battery cell 100 housed in the plurality of holders 330 via a bonding element 355. The bonding element 355 can include electrically conductive material, such as a metallic material, aluminum, or an aluminum alloy with copper. The bonding element 355 can extends from the second busbar 340 to the second bonding element 370 extending from each battery cell 100. The bonding element 355 can be bonded, welded, connected, attached, or otherwise electrically coupled to the second bonding element 370 extending from the battery cell 100. The second bonding element 370 can define the second polarity terminal for the battery cell 100. The second bonding element 370 can include a first end coupled with a surface of the lid 130 (e.g., second portion 140, first portion 135) and a second end coupled with a surface of the bonding element 355. The second busbar 340 can define the second polarity terminal for the battery pack 305.

The first busbar 335 and the second busbar 340 can be separated from each other by the electrically insulating layer 345. The electrically insulating layer 345 can include any electrically insulating material or dielectric material, such as air, nitrogen, sulfur hexafluoride (SF6), porcelain, glass, and plastic (e.g., polysiloxane), among others to separate the first busbar 335 from the second busbar 340. The electrically insulating layer 345 can include spacing to pass or fit the first bonding element 365 connected to the first busbar 335 and the second bonding element 370 connected to the second busbar 340. The electrically insulating layer 345 can partially or fully span the volume defined by the battery case 320 and the capping element 325. A top plane of the electrically insulating layer 345 can be in contact or be flush with a bottom plane of the capping element 325. A bottom plane of the electrically insulating layer 345 can be in contact or be flush with a top plane of the battery case 320.

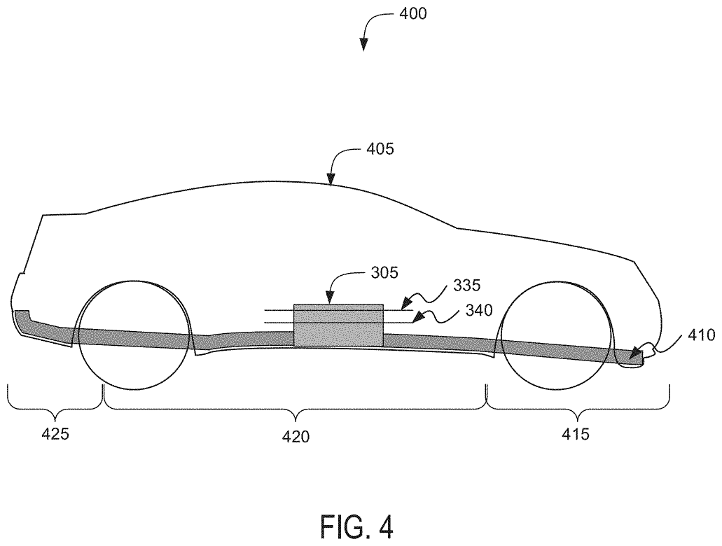

FIG. 4 depicts a cross-section view 400 of an electric vehicle 405 installed with a battery pack 305. The battery pack 305 can include at least one battery cell 100 having at least one cathode 150 that includes an aluminum material 155 having a coating 160 disposed on one or more faces or surfaces of the aluminum material 155. The battery cells 100 described herein can be used to form battery packs 305 residing in electric vehicles 405 for an automotive configuration. For example, the battery cell 100 can be disposed in the battery pack 305 and the battery pack 305 can be disposed in the electric vehicle 405. An automotive configuration includes a configuration, arrangement or network of electrical, electronic, mechanical or electromechanical devices within a vehicle of any type. An automotive configuration can include battery cells for battery packs in vehicles such as electric vehicles (EVs). EV s can include electric automobiles, cars, motorcycles, scooters, passenger vehicles, passenger or commercial trucks, and other vehicles such as sea or air transport vehicles, planes, helicopters, submarines, boats, or drones. EVs can be fully autonomous, partially autonomous, or unmanned. Thus, the electric vehicle 405 can include an autonomous, semi-autonomous, or non-autonomous human operated vehicle. The electric vehicle 405 can include a hybrid vehicle that operates from on-board electric sources and from gasoline or other power sources. The electric vehicle 405 can include automobiles, cars, trucks, passenger vehicles, industrial vehicles, motorcycles, and other transport vehicles. The electric vehicle 405 can include a chassis 410 (e.g., a frame, internal frame, or support structure). The chassis 410 can support various components of the electric vehicle 405. The chassis 410 can span a front portion 415 (e.g., a hood or bonnet portion), a body portion 420, and a rear portion 425 (e.g., a trunk portion) of the electric vehicle 405. The front portion 415 can include the portion of the electric vehicle 405 from the front bumper to the front wheel well of the electric vehicle 405. The body portion 420 can include the portion of the electric vehicle 405 from the front wheel well to the back wheel well of the electric vehicle 405. The rear portion 425 can include the portion of the electric vehicle 405 from the back wheel well to the back bumper of the electric vehicle 405.

The battery pack 305 that includes at least one battery cell 100 having at least one cathode 150 that includes an aluminum material 155 having a coating 160 disposed on one or more faces or surfaces of the aluminum material 155 can be installed or placed within the electric vehicle 405. For example, the battery pack 305 can couple with a drive train unit of the electric vehicle 405. The drive train unit may include components of the electric vehicle 405 that generate or provide power to drive the wheels or move the electric vehicle 405. The drive train unit can be a component of an electric vehicle drive system. The electric vehicle drive system can transmit or provide power to different components of the electric vehicle 405. For example, the electric vehicle drive train system can transmit power from the battery pack 305 to an axle or wheels of the electric vehicle 405. The battery pack 305 can be installed on the chassis 410 of the electric vehicle 405 within the front portion 415, the body portion 420 (as depicted in FIG. 4), or the rear portion 425. A first busbar 435 (e.g., first polarity busbar) and a second busbar 440 (e.g., second polarity busbar) can be connected or otherwise be electrically coupled with other electrical components of the electric vehicle 405 to provide electrical power from the battery pack 305 to the other electrical components of the electric vehicle 405. For example, the first busbar 335 can couple with at least one surface of a battery cell 100 (e.g., lid 130, housing 105) of the battery pack 305 through a wirebond or bonding element (e.g., bonding element 350 of FIG. 3). The second busbar 340 can couple with at least one surface of a battery cell 100 (e.g., lid 130, housing 105) of the battery pack 305 through a wirebond or bonding element (e.g., bonding element 355 of FIG. 3).

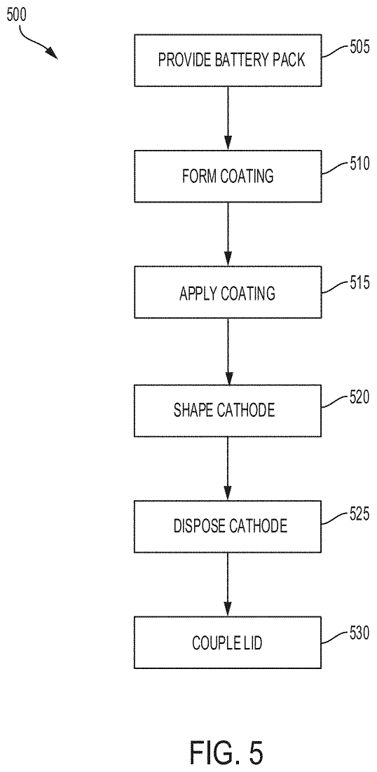

FIG. 5, among others, depicts a flow diagram of a method 500 of providing a battery cell 100 of a battery pack 305 to power an electric vehicle 405. The method 500 can include providing a battery pack 305 (ACT 505). For example, the method 500 can include providing a battery pack 305 having a battery cell 100. The battery cell 100 can include a housing 105 that includes a first end 110 and a second end 115. The housing 105 can be formed having or defining an inner region 120. The battery cell 100 can be a lithium ion battery cell, a nickel-cadmium battery cell, or a nickel-metal hydride battery cell. The battery cell 100 can be part of a battery pack 305 installed within a chassis 410 of an electric vehicle 405. For example, the battery cell 100 can be one of multiple battery cells 100 disposed within a battery pack 305 of the electric vehicle 405 to power the electric vehicle 405. The housing 105 can be formed from a cylindrical casing with a circular, ovular, elliptical, rectangular, or square base or from a prismatic casing with a polygonal base.

The method 500 can include forming a coating 160 (ACT 510). For example, the method 500 can include forming a coating 160 for a plurality of cathodes 150. The coating 160 can include active materials 205 and linear carbon conductive additives 210. The active materials 205 can include lithium nickel cobalt aluminum oxide particles (NCA). For example, the coating 160 can be formed having between 95 wt % and 98 wt % lithium nickel cobalt aluminum oxide particles. Thus, the method 500 can include forming the coating 160 having lithium nickel cobalt aluminum oxide particles 205 and the linear carbon conductive additive 210 that form a connection between a plurality of the lithium nickel cobalt aluminum oxide particles 205. The linear carbon conductive additives 210 can include carbon nanotubes (CNT) or vapor grown carbon nanofibers (VGCF). For example, the coating 160 can be formed having between 0.05 wt % and 1.0 wt % carbon nanotubes. The coating 160 can be formed having forming the coating having between 0.30 wt % and 0.70 wt % vapor grown carbon nanofibers.

Forming the coating 160 using CNT as the linear carbon conductive additive 210 can include combining the linear carbon conductive additives 210 with a binder. For example, the linear carbon conductive additives 210 can be mixed or combined with a binder such as polyvinylidene fluoride power (PVDF powder). The linear carbon conductive additives 210 can be mixed with PVDF powder on a roller mixer, for example, for a time period in a range from ten hours to twenty four hours (e.g., one day). A predetermined amount (e.g., 225 g) of the generated mixture of the linear carbon conductive additives 210 and the PVDF powder can be added to a planetary mixer (e.g., double planetary mixer and planetary dispenser). A conductive agent such as super-P can be combined with the linear carbon conductive additives 210 and PVDF powder mixture. For example, 10 g of additive super-P can be added to the linear carbon conductive additives 210 and PVDF powder mixture. The combination of the linear carbon conductive additives 210, PVDF powder, and the super-P can be mixed in the planetary mixer, for example, at 25/600 rpm. The combination of the linear carbon conductive additives 210, PVDF powder, and the super-P can be mixed in the planetary mixer at 25/600 rpm for five minutes. After five minutes, the planetary mixer speed can be increased to 25/1500 rpm. The planetary mixer can stir the combination of the linear carbon conductive additives 210, PVDF powder, and the super-P for an additional ten minutes as the 25/1500 rpm speed. After the ten minutes, a predetermined amount (e.g., 876.6 g or between 850-950 g) of active materials 205 (e.g., NCA particles, NCA powders) can be gradually added to the combination of the linear carbon conductive additives 210, PVDF powder, and the super-P. The combination of the active materials 205, the linear carbon conductive additives 210, PVDF powder, and the super-P can be mixed or stirred for twenty minutes at a speed of 25/1500 rpm to form a slurry mixture. After the twenty minutes, a coating agent such as N-Methyl-2-pyrrolidone (NMP) can be added the slurry mixture. The NMP can be added to adjust a solid content and viscosity of the slurry mixture. For example, 90.5 g of NMP can be added to the slurry mixture before the end of the mixing process. The NMP can be added over a time period of, for example, thirty minutes. After the thirty minutes, the mixing speed can be reduced to 25/600 rpm. The slurry mixture can be mixed at the speed 25/600 rpm for a longer duration. For example, the slurry mixture can be mixed at the speed 25/600 rpm overnight (e.g., several hours, ten hours, twenty-four hours) inside a dry room having a dew pint of −55° C. The slurry mixture can then be degassed under vacuum for one and a half (e.g., 1.5) hours to form a final form of the coating 160. For example, a solid content of the coating 160 (e.g., slurry mixture) can be in a range of 67% to 70%. The solid content of the coating 160 (e.g., slurry mixture) can vary within or outside this range.

Forming the coating 160 using VGCF as the linear carbon conductive additive 210 can include premixing a binder (e.g., PVDF powder) with NMP. For example, the PVDF powder can be premixed with the NMP on a roller mixer for a predetermined time period (e.g., 24 hours, one day) to form a binder solution of 8% by weight PVDF. The binder solution can be added to a planetary mixer with the linear carbon conductive additives 210 (e.g., VGCF), and a NMP solvent. For example, 4.5 g of linear carbon conductive additives 210 (e.g., VGCF) and 98 g of NMP solvent can be combined with the binder solution and mixed using a planetary mixer. The combination of the linear carbon conductive additives 210, NMP solvent, and binder solution can be mixed at a speed of 25/600 rpm for thirty minutes using the planetary mixer to form a linear carbon conductive additives dispersion (e.g., VGCF dispersion). The speed of the planetary mixer can be increased to 25/1500 rpm to mix or stir the linear carbon conductive additives dispersion. The linear carbon conductive additives dispersion can be stirred at 25/1500 rpm for five minutes. The active materials 205 can be added with the linear carbon conductive additives dispersion. For example, 873 g of active materials 205 (e.g., NCA) can be combined with the linear carbon conductive additives dispersion. Additional NMP can be added with the active materials 205 to the linear carbon conductive additives dispersion. For example, an additional 84 g NMP can be added with the 873 g of active materials 205 to the linear carbon conductive additives dispersion.

The combination of the active materials, additional NMP, and linear carbon conductive additives dispersion can be mixed or stirred using the planetary mixer at a speed of 25/1500 rpm. The combination of the active materials, additional NMP, and linear carbon conductive additives dispersion can be mixed for twenty minutes using the planetary mixer at a speed of 25/1500 rpm to form a slurry mixture. After the twenty minutes, a conductive agent (e.g., carbon black, super-P) can be added to the resulting slurry mixture. For example, 9 g of carbon black can be added to the combination of the active materials, additional NMP, and linear carbon conductive additives dispersion. Additional NMP can be added with the carbon black to adjust a solid content and viscosity of the slurry mixture. For example, an additional 36 g of NMP can be added with the carbon black to adjust a solid content and viscosity of the slurry mixture. The slurry mixture with the additional NMP and carbon black can be stirred for thirty minutes. After thirty minutes, an additional 10 g of NMP can be added to the resulting slurry mixture to further adjust the viscosity. The speed of the planetary mixer can be reduced to 25/600 rpm. After another thirty minutes of stirring, another 10 g of NMP was added to adjust the viscosity and the mixer speed was decreased to 25/600 rpm. The slurry mixture can be mixed at the speed 25/600 rpm for a longer duration. For example, the slurry mixture can be mixed at the speed 25/600 rpm overnight (e.g., several hours, ten hours, twenty-four hours) inside a dry room having a dew pint of −55° C.

The method 500 can include applying a coating 160 (ACT 515). For example, the method 500 can include applying the coating 160 to a first face 165 and a second face 170 of an aluminum material 155 for each of the plurality of cathodes 150. The coating 160 can be disposed on the first face 165 and the second face 170 having a thickness in a range between 150 μm and 250 μm. Applying the coating can include a slot-die coating process to apply the coating 160 to one or more faces 165, 170 or surfaces of the aluminum material 155. The aluminum material 155 can include an aluminum foil such as a 0.3 mm shim sheet of aluminum material or a 0.19 mm shim sheet, that can be used for the slot-die coating process. One or more faces 165, 170 of the aluminum material 155 can be coated with the coating 160. For example, a single sided material loading in a range from 26 mg/cm² to 28 mg/cm² can be formed on a first face 165 of the aluminum material 155. A single sided material loading in a range from 26 mg/cm² to 28 mg/cm² can be formed on a second face 170 of the aluminum material 155. Thus, the first face 165 and the second face 170 can be coated with the coating 160 to form the cathode 150. The coating 160 can be applied to the one or more faces 165, 170 of the aluminum material 155 using a pump cart. For example, the coating 160 can be applied to the one or more faces 165, 170 of the aluminum material 155 using a pump cart at a pump cart pressure maintained in a range from 40 psi to 60 psi (e.g., 50 psi). After the coating 160 is applied to one or more faces 165, 170 of the aluminum material 155, the areal loading of the resulting cathode 150 can be in a range from 50 mg/cm² to 54 mg/cm² (e.g., 52 mg/cm²).

The method 500 can include shaping a cathode 150 (ACT 520). For example, calendering can be performed to smooth or reach a desired thickness of the cathode 150 (or electrode 150). The calendering can be performed to reach a desired thickness of the coating 160 disposed on one or more faces 165, 170 of the cathode 150. The calendering can be performed on one or more surfaces of the aluminum material 155 of the cathode 150. The calendering can be performed on the coating 160 applied to the first face 165. The calendering can be performed on the coating 160 applied to the second face 170. The calendering can be performed on the coating 160 applied to the first face 165 and the second face 170. The cathode 150 can be calendered to a range from 3.50 g/cm³ to 3.70 g/cm³. For example, the cathode 150 can be calendered to a range from 3.54 g/cm³ to 3.57 g/cm³ using the CNT binder. The cathodes 150 generated using the CNT binder and calendered to a size in the 3.54 g/cm³ to 3.57 g/cm³ survived a mechanical flexibility test using a mandrel. The cathode 150 can be calendered to a range from 3.63 g/cm³ to 3.69 g/cm³ using the VCGF binder. The cathodes 150 generated using the VCGF binder and calendered to a size in the 3.63 g/cm³ to 3.69 g/cm³ survived a mechanical flexibility test using a mandrel. For example, a mechanical flexibility of the cathodes 150 (or electrodes 150) can be checked by winding the formed cathodes 150 on a mandrel. The mechanical flexibility of the cathodes 150 (or electrodes 150) can be checked by winding the formed cathodes 150 on a 3 mm diameter mandrel. The winding direction can be the same as the direction the coating 160 was applied and the calendering was performed.

The method 500 can include disposing the cathode 150 (ACT 525). For example, the method 500 can include disposing a plurality of cathodes 150 into the inner region 120 of the housing 105. For example, the cathodes 150 can be disposed within a container within the inner region 120. One or more electrodes 150 can be disposed within the inner region 120 of the housing 105 or within a container within the inner region 120. One or more anodes 150 can be disposed within the inner region 120 of the housing 105 or within a container within the inner region 120. For example, a plurality of cathodes 150 and a plurality of anodes 150 can be disposed within a container within the inner region of the housing 105. The cathodes 150 can electrically couple with the anodes 150 to form the battery cell 100. For example, the cathode 150 can form a cathode portion of the battery cell and electrically couple with the anodes 150 that form an anode portion of the battery cell 100. The cathode portion and the anode portion can be disposed within the container and the container can include an electrolyte. The electrolyte can include any electrically conductive solution, dissociating into ions (e.g., cations and anions). During operation of the battery, the electrons from the electrolyte can pass between the anode portion and the cathode portion.

The method 500 can include coupling a lid 130 (ACT 530). For example, the method 500 can include coupling a lid 130 with the first end 110 of the housing 105 to seal the battery cell 100. The lid 130 can be formed having a first portion 135 and a second portion 140. Coupling the lid 130 can include crimping an edge of the second portion 140 with the first end 110 of the housing 105. For example, an edge surface or outer surface of the second portion 140 can be crimped, bent, or otherwise manipulated to form over at least one surface (e.g., top surface) of the first end 110 of the housing 105. The crimped edge of the second portion 140 can contact and couple with at least one surface of the first end 110 of the housing 105 to seal the battery cell 100. The second portion 140 can couple with an indentation of the first end 110. For example, the indentation can include a groove or deformation formed into the first end 110 of the housing 105 to receive an edge or surface of the second portion of the lid 130. The seal formed by the crimped edge of the second portion 140, between the lid 130 and the first end 110 of the housing 105, can include any type of mechanical seal, such as a hermetic seal, an induction seal, a hydrostatic seal, a hydrodynamic seal, and a bonded seal, among others.

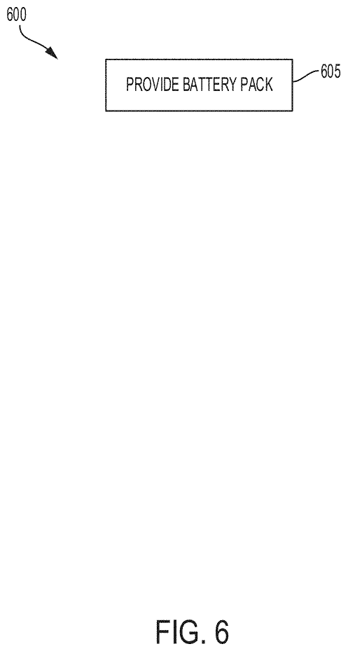

FIG. 6 depicts a method 600. The method 600 can include providing a battery pack 305 having at least one battery cell 100 for electric vehicles 405 (ACT 605). The battery pack 305 can include at least one battery cell 100. The battery cell 100 can include a housing 105 having a first end 110 and a second end 115. The housing 105 can define an inner region 120. The battery cell 100 can include a plurality of cathodes 150 that extend into the inner region 120. Each of the plurality of cathodes 150 can include an aluminum foil 155 having a first face 165 and a second face 170. A coating 160 disposed on the first face 165 and the second face 170. The coating 160 can include lithium nickel cobalt aluminum oxide particles 205 and a linear carbon conductive additive 210 to form a connection between a plurality of the lithium nickel cobalt aluminum oxide particles 205.

While acts or operations may be depicted in the drawings or described in a particular order, such operations are not required to be performed in the particular order shown or described, or in sequential order, and all depicted or described operations are not required to be performed. Actions described herein can be performed in different orders.

Having now described some illustrative implementations, it is apparent that the foregoing is illustrative and not limiting, having been presented by way of example. Features that are described herein in the context of separate implementations can also be implemented in combination in a single embodiment or implementation. Features that are described in the context of a single implementation can also be implemented in multiple implementations separately or in various sub-combinations. References to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any act or element may include implementations where the act or element is based at least in part on any act or element.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can include implementations including a plurality of these elements, and any references in plural to any implementation or element or act herein can include implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

The systems and methods described herein may be embodied in other specific forms without departing from the characteristics thereof. For example the voltage across terminals of battery cells can be greater than 5V. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

Systems and methods described herein may be embodied in other specific forms without departing from the characteristics thereof. For example, descriptions of positive and negative electrical characteristics may be reversed. For example, elements described as negative elements can instead be configured as positive elements and elements described as positive elements can instead by configured as negative elements. Further relative parallel, perpendicular, vertical or other positioning or orientation descriptions include variations within +/−10% or +/−10 degrees of pure vertical, parallel or perpendicular positioning. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

1. A battery cell for a battery pack to power an electric vehicle, the battery cell comprising:
a housing defining an inner region;
a plurality of cathodes that extend into the inner region, each of the plurality of cathodes comprising:
an aluminum material comprising a first face and a second face;
a coating disposed on the first face and the second face, the coating comprising lithium nickel cobalt aluminum oxide particles and a linear carbon conductive additive to form a connection between a plurality of the lithium nickel cobalt aluminum oxide particles;
the coating disposed on the first face having a thickness between 150 μm and 250 μm;
the coating disposed on the second face having a thickness between 150 μm and 250 μm; and
the coating including a plurality of point to line connections, each point to line connection formed between at least one linear carbon additive and multiple lithium nickel cobalt aluminum oxide particles.

2. The system of claim 1, comprising:
the coating including a binder, a conductive agent and a coating agent combined with the lithium nickel cobalt aluminum oxide particles and the linear carbon conductive additive.

3. The system of claim 1, comprising:
the linear carbon conductive additive having at least one of carbon nanotubes and vapor grown carbon nanofibers.

4. The system of claim 1, comprising:
the coating includes between 0.05 wt % and 1.0 wt % carbon nanotubes.

5. The system of claim 1, comprising:
the coating having 0.10 wt % carbon nanotubes.

6. The system of claim 1, comprising:
the coating having between 0.30 wt % and 0.70 wt % vapor grown carbon nanofibers.

7. The system of claim 1, comprising:
the coating includes 0.5 wt % vapor grown carbon nanofibers.

8. The system of claim 1, comprising:
the coating having between 95 wt % and 98 wt % lithium nickel cobalt aluminum oxide particles.

9. The system of claim 1, comprising:
the coating includes 97.4 wt % lithium nickel cobalt aluminum oxide particles.

10. The system of claim 1, comprising:
the battery cell disposed in a battery pack having multiple battery cells.

11. The system of claim 1, comprising:
the battery cell disposed in a battery pack and the battery pack disposed in the electric vehicle.

12. The system of claim 1, comprising:
the battery cell disposed in the electric vehicle.

13. A method of providing a battery cell for a battery pack to power an electric vehicle, the method comprising:
providing a battery pack having a battery cell, the battery cell having a housing that includes a first end and a second end and defines an inner region;
forming a coating for a plurality of cathodes, the coating having lithium nickel cobalt aluminum oxide particles and a linear carbon conductive additive that form a connection between a plurality of the lithium nickel cobalt aluminum oxide particles;
forming a plurality of point to line connections in the coating, each point to line connection formed between at least one linear carbon additive and multiple lithium nickel cobalt aluminum oxide particles;
applying the coating to a first face of an aluminum material in a range between 150 μm and 250 μm for each of the plurality of cathodes;
applying the coating to a second face of the aluminum material in a range between 150 μm and 250 μm for each of the plurality of cathodes; and
disposing the plurality of cathodes into the inner region of the housing.

14. The method of claim 13, comprising:
combining a binder, a conductive agent and a coating agent with the lithium nickel cobalt aluminum oxide particles and the linear carbon conductive additive to form the coating.

15. The method of claim 13, comprising:
the linear carbon conductive additive comprises at least one of carbon nanotubes and vapor grown carbon nanofibers.

16. The method of claim 13, comprising:
forming the coating having between 0.05 wt % and 1.0 wt % carbon nanotubes.

17. The method of claim 13, comprising:
the battery pack disposed in the electric vehicle.

18. The method of claim 13, comprising:
forming the coating having between 0.30 wt % and 0.70 wt % vapor grown carbon nanofibers.

19. The method of claim 13, comprising:
forming the coating having between 95 wt % and 98 wt % lithium nickel cobalt aluminum oxide particles.

20. An electric vehicle, comprising:
a battery pack having a battery cell, the battery cell comprises:
a housing defining an inner region;
a plurality of cathodes that extend into the inner region, each of the plurality of cathodes comprise:
an aluminum material comprises a first face and a second face;
a coating disposed on the first face and the second face, the coating comprises lithium nickel cobalt aluminum oxide particles and a linear carbon conductive additive to form a connection between a plurality of the lithium nickel cobalt aluminum oxide particles;
the coating disposed on the first face having a thickness between 150 μm and 250 μm;
the coating disposed on the second face having a thickness between 150 μm and 250 μm; and
the coating including a plurality of point to line connections, each point to line connection formed between at least one linear carbon additive and multiple lithium nickel cobalt aluminum oxide particles.
